(19) United States
(12) Patent Application Publication
(10) Pub. No.: US 2024/0155405 A1
(43) Pub. Date: May 9, 2024

(54) METHOD AND APPARATUS FOR FEEDBACK CHANNEL STATUS INFORMATION BASED ON MACHINE LEARNING IN WIRELESS COMMUNICATION SYSTEM

(71) Applicant: ELECTRONICS AND TELECOMMUNICATIONS RESEARCH INSTITUTE, Daejeon (KR)

(72) Inventors: An Seok LEE, Daejeon (KR); Han Jun PARK, Daejeon (KR); Yong Jin KWON, Daejeon (KR); Heesoo LEE, Daejeon (KR); Yun Joo Kim, Daejeon (KR); Hyun Seo PARK, Daejeon (KR); Jung Bo Son, Daejeon (KR); Yu Ro LEE, Daejeon (KR)

(21) Appl. No.: 18/503,979

(22) Filed: Nov. 7, 2023

(30) Foreign Application Priority Data
Nov. 7, 2022 (KR) 10-2022-0147078

(51) Int. Cl. H04W 24/10; H04W 24/02

(52) U.S. Cl. CPC H04W 24/10; H04W 24/02

(57) ABSTRACT

A method of a terminal may comprise: transmitting channel state prediction-related information to a base station; receiving a channel prediction request signal for a first time instance from the base station; receiving auxiliary reference signal(s) (RS(s)) and a first RS from the base station based on the channel state prediction-related information; and transmitting channel prediction information for the first time instance to the base station, wherein the channel state prediction-related information includes information indicating that channel state information prediction of the terminal is possible, and the channel prediction request signal includes configuration information of the auxiliary RS(s) and configuration information of the first RS.

### CROSS-REFERENCE TO RELATED APPLICATIONS

This application claims priority to Korean Patent Applications No. 10-2022-0147078, filed on Nov. 7, 2022, with the Korean Intellectual Property Office (KIPO), the entire contents of which are hereby incorporated by reference.

### BACKGROUND

### 1. Technical Field

Exemplary embodiments of the present disclosure relate to a channel prediction technique in a wireless communication system, and more specifically, to a channel prediction technique based on machine learning in a wireless communication system.

### 2. Related Art

The International Telecommunication Union (ITU) is developing the International Mobile Telecommunication (IMT) framework and standards. Recently, it has been discussing 6th generation (6G) communications through a program called ‘IMT for 2030 and beyond.’

Among the technologies for implementing 6G, the fields that are receiving a lot of attention are artificial intelligence (AI) and machine learning (ML). The 3rd Generation Partnership Project (3GPP) started conducting researches on AI/ML technologies for air interfaces from Release-18 (Rel-18). The main use cases of the researches conducted in the 3GPP are as follows.
AI/ML for channel state information (CSI) feedback enhancement
AI/ML for beam management
AI/ML for positioning performance enhancement

In a wireless communication system, when mobility exists in a receiver or its surrounding environments, there may be a phenomenon in which a radio channel changes over time. Therefore, if information delivered using the current CSI delivery scheme, such as in the 4G and 5G systems, is utilized as is, errors due to changes in the radio channel may occur, resulting in inefficiencies such as reduced transmission rates.

In a mobile communication network, efforts are being made to address the aforementioned problem through approaches that involve predicting future channels using ML technology. One of these approaches involves the proposal of a 3D convolutional network, recognized for its capability to effectively process time series information. The 3D convolutional network takes L pieces of past channel information as input and produces channel information predictions for a specific future time.

However, the following considerations for applying the 3D convolutional network to an actual system are lacking. First, a method of configuring information on prediction-related functions supportable by a terminal and a method for a base station to utilize it to configure reference signals and auxiliary reference signals in a form required by the terminal have not been proposed. Second, a method of measuring prediction performance when applied to an actual system has not been proposed. Third, a method of additionally delivering channel measurement information for the current time or delivering the channel measurement information instead of channel prediction information has not been proposed. Lastly, a method of collecting training data for the purpose of training a machine learning model for prediction has not been proposed.

### SUMMARY

Exemplary embodiments of the present disclosure are directed to providing a method and an apparatus for channel prediction, which are capable of resolving the above-described problem.

According to a first exemplary embodiment of the present disclosure, a method of a terminal may comprise: transmitting channel state prediction-related information to a base station; receiving a channel prediction request signal for a first time instance from the base station; receiving auxiliary reference signal(s)(RS(s)) and a first RS from the base station based on the channel state prediction-related information; and transmitting channel prediction information for the first time instance to the base station, wherein the channel state prediction-related information includes information indicating that channel state information prediction of the terminal is possible, and the channel prediction request signal includes configuration information of the auxiliary RS(s) and configuration information of the first RS.

The channel state prediction-related information may include at least one of information on a minimum time interval between the RSs or information on a number of the auxiliary RS(s).

The channel state prediction-related information may include information on a type of the auxiliary RS(s), and the auxiliary RS(s) may include a channel state information (CSI)-RS, channel information of a received physical downlink control channel (PDCCH) resource, channel information of a received physical downlink shared channel (PDSCH) resource, or tracking reference signal.

When the auxiliary RS(s) include a PDCCH, the channel prediction request for the first time instance may be received on the PDCCH.

The channel prediction information for the first time instance may be transmitted to the base station at a time of reporting channel state information (CSI) measured based on reception of the first RS.

The method may further comprise: generating fallback CSI when channel prediction for the first time instance is impossible or when a channel prediction accuracy for the first time instance is equal to or less than a preset value; and transmitting the fallback CSI to the base station, wherein the fallback CSI includes CSI based on measurement of the first RS.

The method may further comprise: receiving a second RS for measuring accuracy of the channel prediction information for the first time instance from the base station at the first time.

The method may further comprise: generating first CSI based on measurement of the second RS; comparing the channel prediction information for the first time instance and the first CSI; identifying the accuracy of the channel prediction information based on a result of the comparison; and transmitting a CSI report message including the accuracy of the channel prediction information to the base station.

The method may further comprise: transmitting a channel state prediction training data request message to the base station when a channel prediction model for channel prediction needs to be trained; receiving configuration information of a second RS for training the channel prediction model from the base station; and collecting training data of the channel prediction model using the second RS received from the base station, based on the configuration information of the second RS.

According to a second exemplary embodiment of the present disclosure, a terminal comprising at least one processor, wherein the at least one processor may cause the terminal to perform: transmitting channel state prediction-related information to a base station; receiving a channel prediction request signal for a first time instance from the base station; receiving auxiliary reference signal(s) (RS(s)) and a first RS from the base station based on the channel state prediction-related information; and transmitting channel prediction information for the first time instance to the base station, wherein the channel state prediction-related information includes information indicating that channel state information prediction of the terminal is possible, and the channel prediction request signal includes configuration information of the auxiliary RS(s) and configuration information of the first RS.

The channel state prediction-related information may include at least one of information on a minimum time interval between the RSs or information on a number of the auxiliary RS(s).

The channel state prediction-related information may include information on a type of the auxiliary RS(s), the auxiliary RS(s) may include a channel state information (CSI)-RS, channel information of a received physical downlink control channel (PDCCH) resource, channel information of a received physical downlink shared channel (PDSCH) resource, or tracking reference signal; and when the auxiliary RS(s) include a PDCCH, the channel prediction request for the first time instance may be received on the PDCCH.

The at least one processor may further cause the terminal to perform: transmitting the channel prediction information for the first time instance to the base station at a time of reporting channel state information (CSI) measured based on reception of the first RS.

The at least one processor may further cause the terminal to perform: generating fallback CSI when channel prediction for the first time instance is impossible or when a channel prediction accuracy for the first time instance is equal to or less than a preset value; and transmitting the fallback CSI to the base station, wherein the fallback CSI includes CSI based on measurement of the first RS.

The at least one processor may further cause the terminal to perform: receiving a second RS for measuring accuracy of the channel prediction information for the first time instance from the base station at the first time; generating first CSI based on measurement of the second RS; comparing the channel prediction information for the first time instance and the first CSI; identifying the accuracy of the channel prediction information based on a result of the comparison; and transmitting a CSI report message including the accuracy of the channel prediction information to the base station.

The at least one processor may further cause the terminal to perform: transmitting a channel state prediction training data request message to the base station when a channel prediction model for channel prediction needs to be trained; receiving configuration information of a second RS for training the channel prediction model from the base station; and collecting training data of the channel prediction model using the second RS received from the base station, based on the configuration information of the second RS.

According to a third exemplary embodiment of the present disclosure, a method of a base station may comprise: receiving channel state prediction-related information from a terminal; transmitting a channel prediction request signal for a first time instance to the terminal; transmitting auxiliary reference signal(s) (RS(s)) and a first RS to the terminal based on the channel state prediction-related information; transmitting a channel prediction request signal for the first time instance to the terminal; and receiving channel prediction information for the first time instance from the terminal, wherein the channel state prediction-related information includes information indicating that channel state information prediction of the terminal is possible, and the channel prediction request signal includes configuration information of the auxiliary RS(s) and configuration information of the first RS.

The channel state prediction-related information may include information on a type of the auxiliary RS(s), the auxiliary RS(s) may include a channel state information (CSI)-RS, channel information of a received physical downlink control channel (PDCCH) resource, channel information of a received physical downlink shared channel (PDSCH) resource, or tracking reference signal; and when the auxiliary RS(s) include a PDCCH, channel prediction for the first time instance may be requested from the terminal by using the PDCCH.

The method may further comprise: transmitting a second RS for measuring accuracy of the channel prediction information for the first time instance to the terminal at the first time; and receiving first channel state information (CSI) based on measurement of the second RS and the accuracy of the channel prediction information from the terminal.

The method may further comprise: receiving a channel state prediction training data request message from the terminal; transmitting configuration information for a second RS for training a channel prediction model to the terminal; transmitting the second RS to the terminal based on the configuration information of the second RS; and transmitting a third RS to the terminal at a second time, which is a prediction time of the terminal based on the configuration information of the second RS.

According to exemplary embodiments of the present disclosure, prediction-based CSI reporting related capability of the terminal is delivered to the base station. The base station receiving it may configure reference signal(s) and/or auxiliary reference signal(s) in a form that allows the terminal to perform prediction. In this case, the terminal may request auxiliary reference signal configuration defining not only a fixed time interval between a reference signal and an auxiliary reference signal, but also the number of auxiliary reference signals within the maximum time window based on a transmission time of the reference signal. In addition, not only CSI-RS(s) but also a PDCCH or PDSCH can be configured as the auxiliary reference signal, thereby reducing a delay and overhead for receiving the auxiliary reference signal.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a sequence chart illustrating a case where a terminal reports predicted CSI to a base station at a request of the base station.

FIG. 4 is a sequence chart illustrating a case where a terminal reports predicted CSI to a base station when the terminal reports auxiliary reference resource information.

FIG. 5 is a sequence chart illustrating a case where a terminal reports CSI predicted using a PDCCH transmitted by a base station to the base station.

FIG. 6 is a sequence chart when reporting fallback CSI based on inaccuracy of predicted CSI or unpredictability of CSI in a terminal.

FIG. 7 is a sequence chart for accuracy measurement of predicted CSI when predicting CSI in a terminal.

FIG. 8 is a sequence chart illustrating a case when a terminal requests training data for CSI prediction and a training procedure is performed.

### DETAILED DESCRIPTION

While the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,”. “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

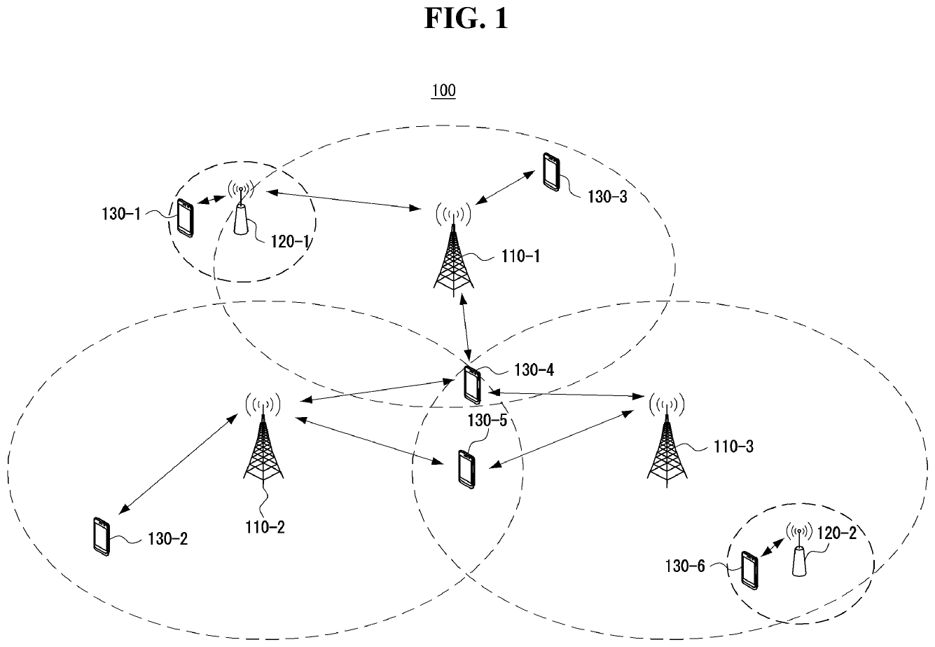

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

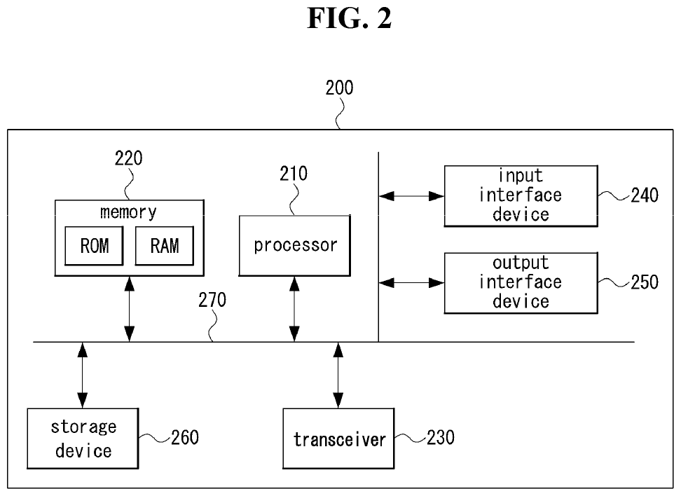

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g., remote radio transmission/reception function, baseband processing function, and the like) of a communication protocol. Alternatively, the remote radio transmission/reception function among all the functions of the communication protocol may be performed by a transmission reception point (TRP) (e.g., flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

The fields that are receiving a lot of attention are artificial intelligence (AI) and machine learning (ML). The 3rd Generation Partnership Project (3GPP) started conducting researches on AI/ML technologies for air interfaces from Release-18 (Rel-18). The main use cases of the researches conducted in the 3GPP are as follows.
AI/ML for channel state information (CSI) feedback enhancement
AI/ML for beam management
AI/ML for positioning performance enhancement

The present disclosure described below is highly relevant to the first use case for improving performance for CSI feedback.

More specifically, in a mobile communication network, a transmitter may perform adjustment of a coding level of a data signal, power allocation, and beamforming using multiple transmission antennas in order to transmit data to a receiver. For this purpose, the transmitter may need to obtain information on a radio channel between antennas of the transmitter and receiver. However, since the channel from the transmitter to the receiver cannot be directly observed at the transmitter, a channel state information (CSI) reporting procedure, which is a procedure for reporting channel information measured at the receiver to the transmitter, is necessary. The CSI may be used as information for scheduling data transmission from the transmitter to the receiver. Examples of the CSI may include rank, channel quality index, and precoding information.

A reference signal such as CSI-reference signal (CSI-RS) has been designed to measure a channel state in the receiver. The transmitter may transmit the CSI-RS periodically or aperiodically. Therefore, the transmitter may configure transmission-related information in advance so that the receiver can receive the CSI-RS transmitted periodically or aperiodically. After receiving the CSI-RS, the receiver may generate CSI based on the received CSI-RS, and the receiver may deliver the generated CSI to the transmitter. This procedure may be referred to as a CSI reporting procedure.

The transmitter may make scheduling decisions and perform link adaptation operations using the received CSI. However, when mobility exists in a receiver or its surrounding environments, there may be a phenomenon in which a radio channel changes over time. Therefore, if information delivered using the current CSI delivery scheme, such as in the 4G and 5G systems, is utilized as is, errors due to changes in the radio channel may occur, resulting in inefficiencies such as reduced transmission rates.

The present disclosure described below will describe a method of configuring information on prediction-related functions supportable by a terminal and a method for a base station to utilize it to configure reference signals and auxiliary reference signals in a form required by the terminal. In addition, the present disclosure will describe a method of measuring prediction performance when applied to an actual system. In addition, the present disclosure will describe a method of additionally delivering channel measurement information for the current time or delivering the channel measurement information instead of channel prediction information. Lastly, the present disclosure will describe a method of collecting training data for the purpose of training a machine learning model for prediction.

In the present disclosure described below, the receiver will be described assuming that it is a terminal, and the transmitter will be described assuming that it is abase station. However, it is obvious to those skilled in the art that transmitters and receivers in various types of wireless communication systems are not limited to the terminal and base station described in the present disclosure. Therefore, it should be noted that the present disclosure described below is applicable to all systems in which the base station is a first communication node and the terminal is a second communication node.

[1] Method of Configuring Reference Signals for Channel State Information Prediction

In the present disclosure, when performing CSI reporting in a mobile communication system consisting of a base station and a terminal, the terminal may notify the base station in advance that it can perform prediction-based CSI reporting through UE capability information. Here, the UE capability information of the terminal may include the following information.
(1) Whether prediction-based CSI reporting is possible
(2) Information related to auxiliary reference resources needed to perform prediction
(3) Information of predictable time(s)

Channel state information prediction-related information of the terminal may be included as information of an AI model and/or ML model, and the base station may receive information on the AI model and/or ML model mounted on the terminal in advance, and derive the above information (1) to (3) from the information on the AI model and/or ML model mounted on the terminal. Alternatively, the terminal may transmit information on the AI model and/or ML model mounted on the terminal to the base station through separate signaling. In the present disclosure described below, various methods for transmitting information on the AI model and/or ML model mounted on the terminal may be used without being limited to a specific method. However, for convenience of description, the description will be made assuming that UE capability information is used.

In addition, the auxiliary reference resource-related information may consist of the number of auxiliary reference signals other than the last received reference signals used to perform CSI prediction in the terminal, transmission time thereof, and type of signals therefor.

In addition, the information on predictable time(s) of the terminal may consist of one or more of the following times.
1) CSI reporting slot
2) Time(s) after a minimum scheduling time from the CSI reporting slot
3) Time(s) after an arbitrary amount of time from the CSI reporting slot

Alternatively, information on predictable time(s) of the terminal may comprise a predictable time period defined by a minimum time and a maximum time from the CSI reporting slot.

According to an exemplary embodiment of the present disclosure, in a mobile communication system consisting of a base station and a terminal, when the terminal performs CSI reporting, the terminal may perform prediction-based CSI reporting. Methods by which the terminal performs prediction may be one of the following.
(1) Use of auto regressive model
(2) Use of AI/ML models

The present disclosure described below mainly assumes that the terminal performs prediction based on an AI/ML model. However, the present disclosure is not limited thereto, and an auto regressive model rather than an AI/ML model may be used, and various other methods may be applied. However, for convenience of description, the following description will be made assuming that an AI/ML model is used. When the terminal notifies the base station that prediction-based CSI reporting is possible using UE capability information, the base station may request a prediction-based CSI report when requesting a CSI report from the terminal. The base station may receive prediction-based CSI, and may obtain channel information more similar at an actual scheduling and transmission time. This will be described regarding the attached drawings.

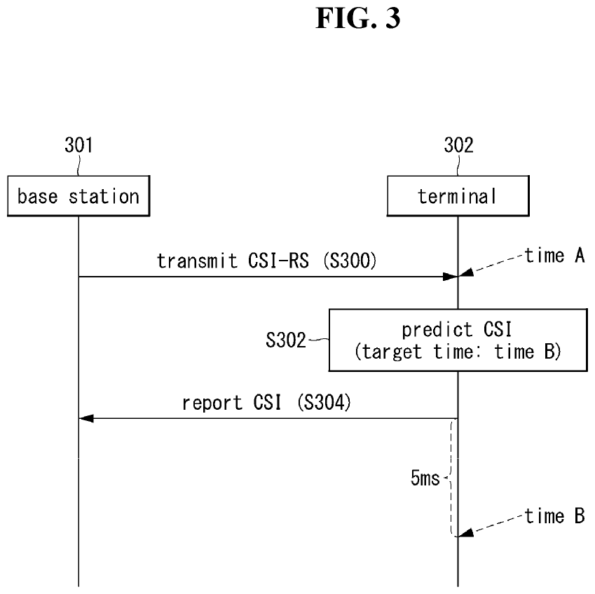

FIG. 3 is a sequence chart illustrating a case where a terminal reports predicted CSI to a base station at a request of the base station.

Referring to FIG. 3, a base station 301 and a terminal 302 are illustrated. Each of the base station 301 and the terminal 302 may include all or part of the components previously described in FIG. 2. Additionally, it should be noted that FIG. 3 illustrates the base station 301 and the terminal 302 to describe a mobile communication system as an example. In other words, as described above, the base station 301 and the terminal 302 may be understood as being replaced with a first communication node and a second communication node, respectively, in various types of wireless communication systems.

In addition, before describing FIG. 3, the description will be made assuming that the base station 301 requests UE capability information from the terminal 302, and in response, the terminal 302 reports the UE capability information to the base station. Various information included in the UE capability information according to the present disclosure may be understood through the following description.

Meanwhile, there may be methods other than UE capability information for delivering information on an AI model and/or ML model for CSI prediction mounted on the terminal 302 to the base station 301. However, in the present disclosure, for convenience of description, the case where UE capability information is used is used as an example.

In a step S300, the base station 301 may transmit a CSI-RS to the terminal 302. Accordingly, the terminal 302 may receive the CSI-RS transmitted by the base station 301. A time at which the base station 302 transmits the CSI-RS and the terminal 302 receives the CSI-RS may be referred to as ‘time A’. The time A may be defined as a time at which the last reference signal (e.g., CSI-RS) is received and/or a time at which CSI prediction starts. Then, the terminal 302 may measure the CSI-RS received at the time A and generate CSI (or predict CSI for a specific time by using the generated CSI).

Meanwhile, it should be noted that FIG. 3 does not illustrate that a prediction request signal requesting prediction of CSI for a specific time (e.g., time B illustrated in FIG. 3) is transmitted from the base station 301 to the terminal 302 in advance. The signal requesting CSI prediction for at a specific time (e.g., time B illustrated in FIG. 3) may be transmitted from the base station 301 to the terminal 302 before the step S300, or may be transmitted to the terminal 302 after the step S300. In addition, the prediction request signal may include CSI-RS configuration information.

Before the step S300, the base station 301 may have identified in advance that the terminal 302 is a terminal from which the base station 301 can receive CSI prediction information, based on the UE capability information as described above. Therefore, the base station 301 may request CSI prediction information for a specific time from the terminal 302. In FIG. 3, it is assumed that predicted information for ‘time B’ is requested and/or that the terminal 302 reports to the base station that prediction for ‘time B’ is possible using the UE capability information. In the exemplary embodiment of FIG. 3, the time B may be a time after 5 ms from a time of reporting the CSI (i.e., CSI reporting time). However, the prediction time may be set to a time after a time shorter than 5 ms or longer than 5 ms from the CSI reporting time. The prediction time may be determined based on a movement speed, movement type (pattern), and/or radio channel environment of the terminal 302. The radio channel environment may refer to a radio channel environment between the base station 301 and the terminal 302.

In a step S302, the terminal 302 may predict CSI. The CSI prediction may be made based on an AI/ML model as described above. The present disclosure describes the case of using an AI/ML model, but it should be noted that it is not limited thereto. Additionally, the terminal 302 may predict CSI for a time preconfigured by the base station 301, for example, the time B. In other words, a target time may be the time B. In the exemplary embodiment of FIG. 3, it may be assumed that the time B is a time after 5 ms from the time of reporting the CSI.

In a step S304, the terminal 302 may report the predicted CSI to the base station 301. In this case, the predicted CSI may be transmitted at a time when CSI measured based on the CSI-RS received at the time A is reported. In addition, the time for which the CSI is predicted may be the time B as described above. Therefore, the base station 301 may receive the predicted CSI report from the terminal 302 in the step S304.

In the exemplary embodiment of FIG. 3 described above, the terminal 302 receives the CSI-RS transmitted by the base station 301, and the terminal 302 may perform CSI prediction for the time B which is a time after 5 ms from the slot in which the CSI measured using the received CSI-RS is reported. In addition, the exemplary embodiment of FIG. 3 corresponds to a case where the terminal 302 transmits the predicted CSI report to the base station 301.

When the terminal 302 simply reports whether the terminal 302 is capable of predicting CSI, the base station 301 may not be able to accurately determine how to configure reference signals for the terminal 302 to perform prediction. Therefore, the present disclosure proposes a method to make this possible.

The terminal 302 may additionally include information on auxiliary reference resource(s) (i.e., auxiliary reference resource information) needed to perform prediction in the UE capability information, and transmit it to the base station 301. Then, the base station 301 may be configured to transmit auxiliary reference resource(s) based on the auxiliary reference resource information included in the UE capability information.

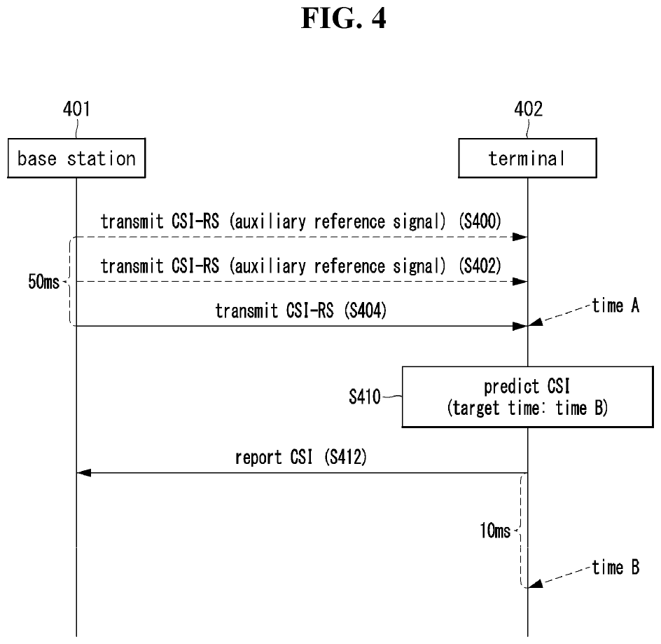

FIG. 4 is a sequence chart illustrating a case where a terminal reports predicted CSI to a base station when the terminal reports auxiliary reference resource information.

Referring to FIG. 4, a base station 401 and a terminal 402 are illustrated. The base station 401 and terminal 402 illustrated in FIG. 4 may include the same components as each of the base station 301 and terminal 302 described previously in FIG. 3. Therefore, redundant descriptions will be omitted.

In addition, before describing FIG. 4, the description will be made assuming that the base station 401 requests UE capability information from the terminal 402, and in response, the terminal 402 reports the UE capability information to the base station 401. There may be other methods for the base station 401 to obtain information on an AI model and/or ML model for CSI prediction mounted on the terminal 402 in addition to the UE capability information. However, in the present disclosure, for convenience of description, the case where UE capability information is used will be described as an example. Various information included in the UE capability information according to the present disclosure may be understood through the following description.

In steps S400 to S404, the base station 401 may transmit a CSI-RS to the terminal 402. Accordingly, the terminal 402 may receive the CSI-RS transmitted by the base station 401, and measure the received CSI-RS.

Before the step S400, the base station 401 may have identified in advance that the terminal 402 is a terminal from which the base station 401 can receive CSI prediction information, based on the UE capability information as described above. In addition, the base station 401 may have acquired information on auxiliary reference signal(s) required for CSI prediction from the terminal 402 based on the UE capability information. In FIG. 4, it is assumed that the UE capability information transmitted by the terminal 402 indicates that the terminal 402 requires two auxiliary reference signals to be transmitted, and that the auxiliary reference signals and the (conventional) reference signal are required within 50 ms.

Accordingly, the base station 401 may transmit a CSI-RS as a first auxiliary reference signal to the terminal 402 in the step S400, and then the base station 401 may transmit a CSI-RS as a second auxiliary reference signal to the terminal 402 in the step S402. Also, in the step S404, the base station 401 may transmit a CSI-RS that is not an auxiliary reference signal. In this case, a time from when the first auxiliary reference signal is transmitted, that is, from the step S400, to when the CSI-RS, which is a conventional reference signal not the auxiliary reference signal, is received is exemplified as 50 ms. Here, 50 ms may be included as CSI prediction-related information in the UE capability information. In other words, the terminal 402 may transmit, to the base station 401, information on a reference signal reception interval indicating a time from the first auxiliary reference signal to a time of receiving the last reference signal for channel prediction by including it as the CSI prediction-related information in the UE capability information. Therefore, the base station 401 may transmit the auxiliary reference signal(s) and the normal reference signal within the reference signal reception interval based on the CSI prediction-related information included in the UE capability information.

A time at which the base station 401 transmits the last CSI-RS and the terminal 402 receives the CSI-RS may be referred to as ‘time A’. The time A may be defined as a time at which the last reference signal (e.g., CSI-RS) is received and/or a time at which the CSI prediction starts. Then, the terminal 401 may measure the CSI-RS received at the time A and generate (or predict) CSI.

In the example of FIG. 4, the base station 401 may have requested CSI prediction information for a specific time from the terminal 402. Alternatively, the terminal 402 may have reported to the base station that CSI prediction for a specific time is possible through the UE capability information. If the base station 401 requests CSI prediction information from the terminal 402, a prediction information request may be transmitted to the terminal 402 using a prediction request signal. The prediction request signal may include CSI-RS configuration information and/or auxiliary RS configuration information.

In FIG. 4, it is assumed that prediction information for a time B is requested (or reported based on the UE capability information). In the exemplary embodiment of FIG. 4, the time B may be a time after 10 ms from a time of CSI reporting (i.e., CSI reporting time). However, the prediction time may be set to a time after a time shorter than 10 ms or longer than 10 ms from the CSI reporting time. The prediction time may be determined based on a movement speed, movement type (pattern), and/or radio channel environment of the terminal 402. The radio channel environment may refer to a radio channel environment between the base station 401 and the terminal 402.

It should be noted that FIG. 4 does not illustrate that a prediction request signal requesting CSI prediction for a specific time (e.g., time B illustrated in FIG. 4) is transmitted from the base station 401 to the terminal 402 in advance. The signal requesting CSI prediction for a specific time (e.g., time B illustrated in FIG. 4) may be transmitted from the base station 401 to the terminal 402 before the step S400, or may be transmitted to the terminal 402 after the step S404.

In a step S410, the terminal 402 may predict CSI. The CSI prediction may be made based on an AI/ML model as described above. The present disclosure describes a case of using an AI/ML model, but it should be noted that it is not limited thereto. In addition, the terminal 402 may predict CSI for a time preconfigured by the base station 401, for example, the time B. In other words, a target time may be the time B. In the exemplary embodiment of FIG. 4, it may be assumed that the time B is a time after 10 ms from the CSI reporting time.

In a step S412, the terminal 402 may report the predicted CSI to the base station 401. In this case, the predicted CSI may be transmitted at a time at which CSI measure based on the CSI-RS received at the time A is reported. In addition, a time for which the CSI is predicted may be the time B as described above. Therefore, the base station 401 may receive the predicted CSI report from the terminal 402 in the step S412.

In the exemplary embodiment of FIG. 4 described above, as an example of auxiliary reference resource configuration, in order for the terminal 402 to perform prediction, two auxiliary reference signals may be further configured to the terminal 402 before the last reference signal (i.e., conventional reference signal to be transmitted), and the two auxiliary reference signals and the last reference signal may be transmitted within 50 ms. Therefore, the terminal 402 may perform CSI prediction based on the auxiliary reference signals and the conventional reference signal.

In the example of FIG. 4 described above, the case where two auxiliary reference signals are transmitted may be a case where two more auxiliary reference signals are needed within a maximum of 50 ms from a time (i.e., time A) of performing prediction which is a reception time of the conventional reference signal.

Here, before performing the steps S400 and S402, the base station 401 may identify in advance whether two more auxiliary reference signals can be received within 50 ms. If the terminal 402 can receive a reference signal that can be used as an auxiliary reference signal within 50 ms even when the base station 401 does not transmit additional auxiliary reference signals, the base station 401 may not transmit the auxiliary reference signal.

If the terminal 402 cannot receive a reference signal that can be used as an auxiliary reference signal within 50 ms when the base station 401 does not transmit additional auxiliary reference signal(s), the base station 401 may configure and transmit two auxiliary reference signals to the terminal 402, as illustrated in FIG. 4.

As another example of auxiliary reference resource configuration, in order for the terminal 402 to perform prediction, there may be a case where two additional auxiliary reference signals with an interval of 5 ms are required before the conventional reference signal. In this case, an interval between the first auxiliary reference signal transmitted in the step S400 of FIG. 4, the second auxiliary reference signal transmitted in the step S402, and the reference signal transmitted last may be 5 ms. In other words, in FIG. 4, the first auxiliary reference signal, the second auxiliary reference signal, and the reference signal are not transmitted within a 50 ms period, but the first auxiliary reference signal, the second auxiliary reference signal, and the reference signal may be configured to be transmitted within a period of 10 ms.

It should be noted that the exemplary embodiment described in FIG. 4 is a procedure for describing the case of using one or more auxiliary reference signals in addition to the conventional reference signal.

The CSI prediction may have different predictable time configurations depending on the terminal's capability, prediction scheme, type of ML model, training, and/or the like. If there is no predictable time information for each terminal, the base station may not know which time can be a target of prediction requested from each terminal. Therefore, the base station may need to obtain information on for which time prediction is possible for each terminal.

In the present disclosure, in order for the base station to know information on for which time prediction is possible for each terminal, information on the predictable times of the terminal may be included in UE capability information.

For example, the terminal may use a prediction model to predict and report CSI for a time of CSI reporting. As another example, the terminal may predict and report CSI for a time after a minimum scheduling time from the time of CSI reporting by utilizing the prediction model. As another example, the terminal may predict and report CSI for a specific time (a time after 10 ms) from the time of CSI reporting.

In the present disclosure, when performing CSI reporting in a mobile communication system consisting of a base station and a terminal, the terminal may report to the base station information required for performing CSI prediction as one of UE capability information. In this case, the UE capability information according to the present disclosure may include information on auxiliary reference resource(s) necessary for performing CSI prediction.

Information on the auxiliary reference resource(s) may be channel prediction-related information. The auxiliary reference signal resource information included as the channel prediction-related information may include one or more of a maximum time interval from a reference time, minimum and maximum number of auxiliary reference signals, and minimum time interval between the reference signal and the auxiliary reference signal. Here, the minimum time interval between the reference signal and the auxiliary reference signal may correspond to the ‘reference signal reception interval’ described above. Additionally, the reference time may be configured as one of the following.
Reference signal reception time (or prediction performance time)
CSI reporting time

In an exemplary embodiment of the present disclosure, the terminal may transmit UE capability information to the base station. Additionally, the UE capability information may inform the base station that at least one auxiliary reference signal is required within a maximum of 50 ms based on a CSI prediction performance time to perform CSI prediction.

The base station receiving the UE capability information including the above information may identify whether one or more auxiliary reference resources are configured within a maximum time interval from the prediction performance time of the terminal. If there are no pre-allocated auxiliary reference resources, the base station may transmit CSI report request information including auxiliary reference signal information to the terminal to enable an reception and prediction operation of the auxiliary reference signal. If the number of pre-allocated auxiliary reference resources exceeds the minimum number of auxiliary reference signals required by the terminal, the base station may not allocate additional auxiliary reference resources.

In addition, when the base station configures auxiliary reference resource information required for CSI prediction based on the UE capability information, the type of reference resources required for CSI prediction may be configured as channel state prediction-related information. The type of reference resource constituting the channel state prediction-related information may correspond to one or more of the information below.
CSI-RS
Channel information of a received physical downlink control channel (PDCCH) resource
Channel information of a received physical downlink shared channel (PDSCH) resource
Tracking reference signal (TRS)

As illustrated above, according to an exemplary embodiment of the present disclosure, the terminal may derive channel measurement information (i.e., CSI) from channel information of a received PDCCH resource or channel information of a received PDSCH resource. Then, terminal may perform CSI prediction using the derived channel measurement information. In other words, the terminal may use channel information derived from a received PDCCH resource or received PDSCH resource as an auxiliary reference signal. If the terminal can use channel information derived from the received PDCCH or the received PDSCH resource as an auxiliary reference signal, it may inform the base station by including it in the UE capability information. Therefore, if there is a previously transmitted PDCCH or transmitted PDSCH within a maximum time interval from a prediction time of the terminal based on the UE capability information, the base station may not perform allocation and signaling of additional auxiliary reference signal(s). In other words, the base station may regard the previously transmitted PDCCH or previously transmitted PDSCH as being used by the terminal as an auxiliary reference resource. In this case, the previously transmitted PDCCHs or transmitted PDSCHs may be more than the minimum number of reference signals required by the UE capability information.

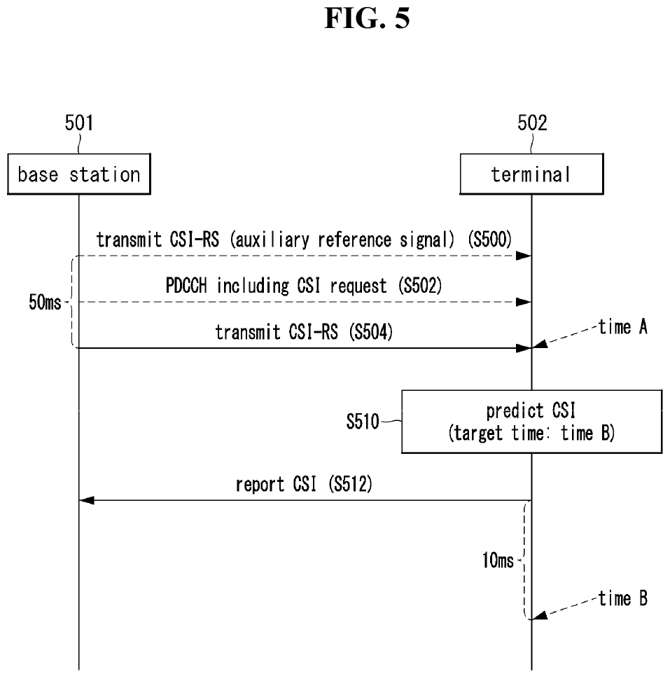

FIG. 5 is a sequence chart illustrating a case where a terminal reports CSI predicted using a PDCCH transmitted by a base station to the base station.

Referring to FIG. 5, a base station 501 and a terminal 502 are illustrated. The base station 501 and the terminal 502 illustrated in FIG. 5 may include the same components as the base station 301 and the terminal 302 respectively described in FIG. 3. Therefore, redundant description will be omitted.

In addition, before describing FIG. 5, the description will be made assuming that the base station 501 requests UE capability information from the terminal 502, and in response, the terminal 502 reports the UE capability information to the base station 501. There may be other methods for the base station 501 to obtain information on an AI model and/or ML model for CSI prediction mounted on the terminal 502 in addition to the UE capability information. However, in the present disclosure, for convenience of description, the case where UE capability information is used will be described as an example. Various information included in the UE capability information according to the present disclosure may be understood through the following description.

In a step S500, the base station 501 may transmit an auxiliary CSI-RS to the terminal 502. In a step S502, the base station 501 may transmit a PDCCH including CSI request information to the terminal 502. In a step S504, the base station 501 may transmit a CSI-RS to the terminal 502.

Here, the base station 501 may transmit the CSI request information based on UE capability information when transmitting the PDCCH. For example, as described above, the terminal may have reported to the base station 501 that terminal 502 can use channel information derived from a PDSCH and/or PDCCH resource as an auxiliary reference signal through the UE capability information. Therefore, when performing the step S502, the base station 501 may identify whether a sum of the numbers of previously transmitted (auxiliary) CSI-RS(s) and/or PDCCH(s) and CSI-RS(s) to be transmitted later is greater than or equal to the minimum required number of reference signals based on the UE capability information.

If the minimum number of reference signals included in the UE capability information is 2 and a PDCCH can be used as an auxiliary reference signal, the base station 501 may identify that the minimum number of reference signals can be satisfied only with the PDCCH in the step S502 and the CSI-RS in the step S504. If the minimum number of reference signals included in the UE capability information is 3 and a PDCCH can be used as an auxiliary reference signal, the base station 501 may identify that the minimum number of reference signals can be satisfied only with the signals transmitted in the steps S500, S502, and S504.

Therefore, if corresponding to at least one of the above cases, the base station 501 may transmit a PDCCH including a CSI request to the terminal 502 in the step S502.

Therefore, the terminal 502 may obtain channel state information using the auxiliary CSI-RS transmitted by the base station 501 in the step S500, the PDCCH transmitted in the step S502, and the CSI-RS transmitted in the step S504, respectively. In other words, the terminal 502 may obtain CSI by measuring the auxiliary CSI-RS received in the step S500, the terminal 502 may obtain CSI using the channel information derived from a resource of the PDCCH received in the step S502, and the terminal 502 may obtain CSI by measuring the CSI-RS received in the step S504.

Meanwhile, it should be noted that FIG. 5 does not illustrate that a prediction request signal requesting CSI prediction for a specific time (e.g., time B illustrated in FIG. 5) is transmitted from the base station 501 to the terminal 502 in advance. The signal requesting CSI prediction for a specific time (e.g., time B illustrated in FIG. 5) may be transmitted from the base station 501 to the terminal 502 before the step S500, or may be transmitted to the terminal 502 after the step S504. If the base station 501 requests CSI prediction information from the terminal 502, a prediction information request may be transmitted to the terminal 502 using the prediction request signal. The prediction request signal may include CSI-RS configuration information and/or auxiliary RS configuration information.

A time at which the base station 501 transmits the last CSI-RS and the terminal 502 receives the CSI-RS may be referred to as ‘time A’. The time A may be defined as a time at which the last reference signal (e.g., CSI-RS) is received and/or a time at which CSI prediction starts. Then, the terminal 501 may measure CSI-RSs received a preset number of times at and before the time A and predict CSI for the specific time. Here, the specific time may be indicated by a time after a preconfigured time from the CSI reporting time. In the exemplary embodiment of FIG. 5, the specific time may be assumed as a time after 100 ms from the CSI reporting. In FIG. 5, the specific time, that is, the time at which CSI prediction information is applied, is illustrated as ‘time B’.

In the exemplary embodiment of FIG. 5, it is assumed that the time B is 10 ms, but this is merely an example and is not limited thereto. In other words, the prediction time may be set to a time shorter than 10 ms or longer than 10 ms. The prediction time may be determined based on a movement speed, movement type (pattern), etc. of the terminal 502.

In a step S510, the terminal 502 may predict CSI. The CSI prediction may be made based on an AI/ML model as described above. The disclosure describes a case of using an AI/ML model, but it should be noted that it is not limited thereto.

Additionally, the terminal 502 may predict CSI for a time preconfigured by the base station 501, for example, the time B. In other words, a target time may be the time B.

In a step S512, the terminal 402 may report the predicted CSI to the base station 501. In this case, the predicted CSI may be transmitted at a time at which CSI generated based on the CSI-RS received at the time A is reported. In addition, the time for which CSI is predicted may be the time B as described above. Therefore, the base station 501 may receive the predicted CSI report from the terminal 502 in the step S512.

According to the present disclosure, when the terminal configures information on auxiliary reference resources required for performing CSI prediction as one of the UE capability information, the terminal may configure the minimum and maximum number of auxiliary reference resources with a fixed time interval. Therefore, the UE capability information reported by the terminal to the base station may include information on the number of reference resources with a fixed time interval required to perform CSI prediction. In this case, information on the number of reference resources with a fixed time interval may include at least one of the minimum number or maximum number.

The terminal may configure information on the auxiliary reference signals for CSI prediction in the UE capability information as follows. It may be configured in the UE capability information that at least two auxiliary reference signals with a time interval of up to 5 ms based on the prediction time are required to perform CSI prediction. The terminal may transmit the UE capability information configured as described above to the base station. Therefore, based on the UE capability information, the base station may identify that the terminal requires at least two auxiliary reference signals with a time interval of up to 5 ms based on the prediction time to perform CSI prediction.

Accordingly, the base station may allocate two preceding auxiliary reference signals at a 5 ms interval based on the prediction performance time of the terminal. Then, the base station may transmit CSI report request information to the terminal including the auxiliary reference signal information. If the configuration of the auxiliary reference signals is the same as the reference signal for performing CSI prediction, periodicity information may be added to the configuration of the reference signals, and the CSI report request information in which the auxiliary reference signal information is omitted to the terminal.

[2] Method for Reporting Channel State Information Based on Predictions

In the present disclosure, when performing CSI reporting in a mobile communication system consisting of a base station and a terminal, the base station may request prediction-based CSI reporting from a terminal capable of prediction-based CSI reporting. In this case, the base station may request a prediction-based CSI report targeting one or more of predictable times or predictable periods of the terminal reported through the terminal's capability information. In addition, the base station may configure periodic or aperiodic prediction-based CSI reporting of the terminal.

According to an exemplary embodiment of the present disclosure, the terminal may transmit information on at least one of the following predictable times to the base station using UE capability information.
(1) CSI reporting time
(2) A time after 5 ms from the CSI reporting time
(3) A time after 10 ms from the CSI reporting time

Based on the above-described UE capability information, the base station may transmit a CSI report request to the terminal including information requesting predicted CSI for a time after 5 ms or 10 ms from the CSI reporting time.

Based on the information requesting the predicted CSI, the terminal may predict CSI for a time after 5 ms from the CSI reporting time based on reference signal and auxiliary reference signal(s) specified in the CSI report request. Then, the terminal may report the predicted CSI to the base station at the CSI reporting time.

In addition, according to the present disclosure, even when the terminal receives information indicating prediction-based CSI reporting, it may not transmit a predicted CSI report to the base station in specific cases. The following situations may correspond to the cases when the terminal does not report predicted CSI to the base station despite receiving a CSI report request.
1) When CSI prediction is impossible in the terminal,
2) When CSI prediction accuracy is very low

In the case 2), the terminal may selectively report either a current CSI measurement result that is not based on prediction or a best CSI prediction result. In this case, when reporting the current CSI measurement result or best CSI prediction result in a fallback mode, a CSI report including the type of CSI being reported may be transmitted to the base station. Here, the type of CSI transmitted to the base station may indicate one of information examples below.
A. Predicted CSI
B. Best predicted CSI
C. Current CSI

When the reported CSI type indicates the best predicted CSI or current CSI, information on a reason for prediction failure may be additionally reported. In this case, the reason for prediction failure may be one of the following. The reported CSI type and failure reason information may be encoded separately from the predicted CSI.
a. CSI prediction cannot be performed
b. Prediction model configuration error
c. Lack of input data (auxiliary reference signal, etc.)
d. Low CSI prediction accuracy

The reason for prediction failure may include at least one of the cases a to d exemplified above. If there are other reasons for prediction failure, these may be included as the reasons for prediction failure. It should be noted that the reasons a to d for prediction failure described above are merely examples and are not limited to the described above four reasons.

In order for the terminal to transition to the fallback mode on its own and report the current CSI measurement result or best CSI prediction result, a criterion for transitioning to the fallback mode may be required. To this end, the base station may inform a threshold for mode transition to the terminal in advance. Therefore, the terminal may determine whether to transition to the fallback mode based on the threshold previously informed by the base station.

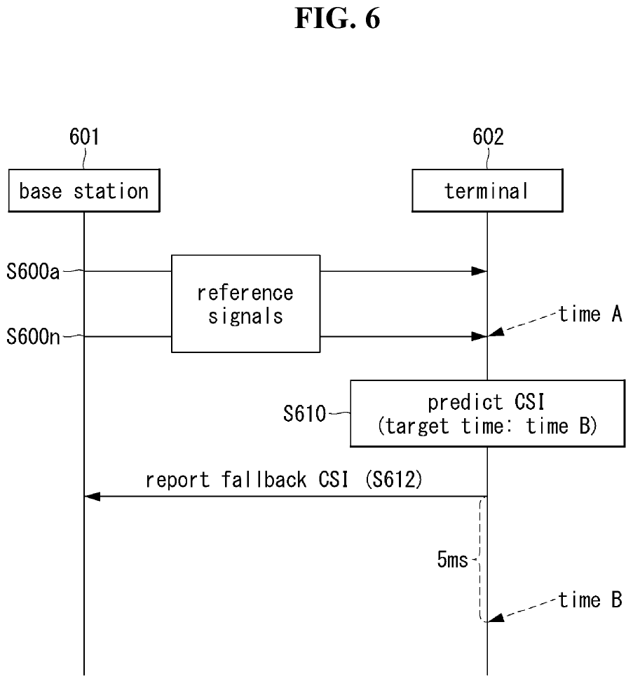

FIG. 6 is a sequence chart when reporting fallback CSI based on inaccuracy of predicted CSI or unpredictability of CSI in a terminal.

Referring to FIG. 6, a base station 601 and a terminal 602 are illustrated. The base station 601 and the terminal 602 illustrated in FIG. 6 may include the same components as the base station 301 and the terminal 302 previously described in FIG. 3. Therefore, redundant description will be omitted.

In addition, before describing FIG. 6, the description will be made assuming that the base station 601 requests UE capability information from the terminal 602, and in response, the terminal 602 reports the UE capability information to the base station 601. There may be other methods for the base station 601 to obtain information on an AI model and/or ML model for CSI prediction mounted on the terminal 602 in addition to the UE capability information. However, in the present disclosure, for convenience of description, the case where UE capability information is used will be described as an example. Various information included in the UE capability information according to the present disclosure may be understood through the following description.

In steps S600a to S600n, the base station 601 may transmit reference signals to the terminal 602. In this case, reference signals may be transmitted based on CSI prediction-related information included in UE capability information reported by the terminal 602. For example, when the terminal 602 indicates in the UE capability information that CSI prediction is possible, the UE capability information may include various information described in [1], such as the minimum and/or maximum number of auxiliary reference signals, periodicity information of auxiliary reference signals, information on signal(s) (or channel(s)) usable as auxiliary reference signals, and CSI predictable time(s). Therefore, all reference signals transmitted in the steps S600a to S600n may be CSI-RSs, or may include PDCCH(s), PDSCH(s), TRS(s), and/or CSI-RS(s).

The terminal 602 may receive reference signals transmitted by the base station 602 in the steps S600a to S600n. In this case, if the reference signal in the step S600n is a last reference signal, a time A may be a time at which the terminal 602 starts CSI prediction and/or a time at which the last reference signal is received, as described in [1].

Meanwhile, it should be noted that FIG. 6 does not illustrate that a prediction request signal requesting CSI prediction for a specific time (e.g., time B illustrated in FIG. 6) is transmitted from the base station 601 to the terminal 602 in advance. The signal requesting CSI prediction for a specific time (e.g., time B illustrated in FIG. 6) may be transmitted from the base station 601 to the terminal 602 before the step S600a, or may be transmitted to the terminal 602 after the step S600n. If the base station 601 requests CSI prediction information from the terminal 602, a prediction information request may be transmitted to the terminal 602 using the prediction request signal. The prediction request signal may include CSI-RS configuration information and/or auxiliary RS configuration information.

In a step S610, the terminal 602 may perform CSI prediction. In this case, a CSI prediction target time may be the time B. In FIG. 6, a time after 5 ms (from the CSI reporting time) is shown as the target time. Although the terminal 601 performs CSI prediction, a case where the terminal is unable to predict CSI or the CSI prediction accuracy is very low may occur as described above.

In a step S612, the terminal 602 may report fallback CSI. In this case, a fallback CSI reporting time may a time at which CSI measured based on the CSI-RS received at the time A is reported. In addition, in the present disclosure, a fallback CSI reporting message may be a message transmitted when prediction is impossible or prediction accuracy is very low. Therefore, the fallback CSI reporting message may include information indicating the fallback CSI reporting and information on the CSI measured at the time A. As another example, the fallback CSI reporting message may include information indicating the fallback CSI reporting and information on best predicted CSI. In addition, as described above, the fallback CSI reporting message may additionally include information on a reason for prediction failure, for example, at least one of a to d described above or other reason information.

Meanwhile, in the present disclosure, when performing CSI reporting in a mobile communication system consisting of a base station and a terminal, the base station may request a prediction-based CSI report from a terminal capable of prediction-based CSI reporting. In this case, the base station may request CSI reporting by indicating one of predictable times of the terminal as a prediction time. In the disclosure, in addition to predicted CSI, the base station may further request information on measured CSI for the current time.

The type of measured CSI for the current time requested by the base station may be one or part of the types of CSI based on prediction. The information on the measure CSI for the current time may be reported in a form of a difference value from the predicted CSI.

For example, the base station may request the terminal to report CSI for a time after 5 ms from a CSI reporting time. When the CSI for which reporting is requested is a rank indicator (RI), channel quality indicator (CQI), or precoding matrix indicator (PMI), the base station may additionally request CQI for the current time from the terminal.

If it is indicated to report both the predicted CSI and the current CSI, the terminal may generate the predicted CSI for a time after a preset time from the CSI reporting time based on reference signal(s) and auxiliary reference signal(s). In addition, CSI for a time at which reference signal(s) are received (i.e., time A) may be generated. For example, if CSI is predicted for a time after 5 ms from the CSI reporting time, the terminal may report the predicted CSI for the time after 5 ms from the CSI reporting time and the CQI measured at the time A which is a measurement time.

It may be assumed that predicted CQI for the time B, which is a prediction target time, is CQI_predict, and the measured CQI for the current time is CQI_present. Then, the CQI for the time A, which is the measurement time, may be reported as a CQI difference value (e.g., CQI_delta). The CQI difference value may be a difference between the predicted CQI CQI_predict and the CQI CQI_present measured at the measurement time.

Meanwhile, according to the present disclosure, when CSI reporting is performed in a mobile communication system consisting of a base station and a terminal, and the base station requests a prediction-based CSI report from the terminal, the base station may request the terminal to report time(s) having the best CSI among a plurality of candidate predictable times. In this case, requested prediction target time(s) may be among predictable times supportable by the terminal. According to an exemplary embodiment, the base station may request CSI report(s) from the terminal for the following target times as candidate target time(s).
1) Current time
2) CSI reporting time
3) A time after 5 ms from the CSI reporting time
4) A time after 10 ms from the CSI reporting time

When CSI reporting is requested for multiple times as described above, the terminal may derive CSI for the current time using reference signal(s). Additionally, the terminal may predict CSI for a CSI reporting time using reference signal(s) and auxiliary reference signal(s). Additionally, the terminal may predict CSI for a time after 5 ms or 10 ms from the CSI reporting time by using reference signal(s) and auxiliary reference signal(s). After obtaining the four types of information as described above, the terminal may report to the base station a time having the best channel quality and the CSI for the time among all the times. Here, as an example of a method for comparing channel qualities, comparison may be made using the measured CQI and the predicted CQI.

[3] Method for Measuring Prediction Accuracy of Channel State Information Prediction Method

In the present disclosure, in a mobile communication system consisting of a base station and a terminal, the terminal may derive CSI based on prediction and report it to the base station. In this case, the base station may transmit a target reference signal to the terminal to measure prediction accuracy at a time at which the prediction of the terminal is made. Then, the terminal may measure the prediction accuracy by measuring the target reference signal and comparing it with the predicted value reported to the base station.

To perform the above-described procedure, the base station may transmit CSI report request information including information on the target reference signal to the terminal. Configuration of the target reference signal may be the same as the reference signal used to perform prediction. If the target reference signal and the reference signal for prediction have the same configuration, the information on the target reference signal may be omitted from the CSI report request information.

Additionally, the base station may request the terminal to report the measured prediction accuracy. In order for the terminal to report the prediction accuracy, the CSI report request information may further include allocation information of resources for the prediction accuracy reporting.

When the terminal performs a prediction for a time after 5 ms from the CSI reporting time, in order to measure the accuracy of the prediction, the base station may transmit a target reference signal to the terminal for the purpose of measuring the prediction accuracy at the time after 5 ms from the CSI reporting time.

To this end, the base station may transmit CSI report request information including information on the target reference signal to the terminal. The configuration of the target reference signal may be the same as that of the reference signal used to perform prediction, and in this case, the information on the target reference signal may be omitted from the CSI reporting request information.

The following schemes may be applied to represent the prediction accuracy.
Cosine similarity
Mean square error (MSE) or normalized MSE (NMSE)

The terminal may measure the prediction accuracy and use it as a quality of a prediction model. If the quality of the prediction model is greatly reduced, the terminal may indicate that CSI prediction is impossible when reporting UE capability information to the base station. As another example, when the quality of the prediction model is greatly reduced, the terminal may proceed with additional training of the prediction model.

Additionally, the base station may request prediction accuracy measurement and reporting from the terminal. To this end, the base station may transmit a CSI report request to the terminal so that the terminal can measure one or more prediction accuracies. Additionally, the base station may request a report of prediction accuracy from the terminal through the CSI report request. In this case, the base station may transmit resource allocation information for prediction accuracy reporting to the terminal by including it in the CSI report request.

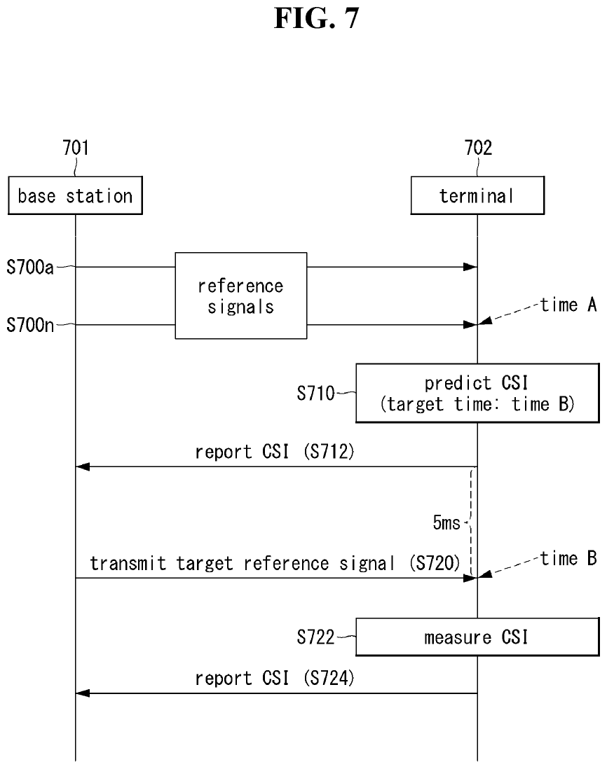

FIG. 7 is a sequence chart for accuracy measurement of predicted CSI when predicting CSI in a terminal.

Referring to FIG. 7, a base station 701 and a terminal 702 are illustrated. The base station 701 and the terminal 702 illustrated in FIG. 7 may include the same components as the base station 301 and the terminal 302 respectively described in FIG. 3. Therefore, redundant description will be omitted.

In addition, before describing FIG. 7, the description will be made assuming that the base station 701 requests UE capability information from the terminal 702, and in response, the terminal 702 reports the UE capability information to the base station 701. There may be other methods for the base station 701 to obtain information on an AI model and/or ML model for CSI prediction mounted on the terminal 702 in addition to the UE capability information. However, in the present disclosure, for convenience of description, the case where UE capability information is used will be described as an example. Various information included in the UE capability information according to the present disclosure may be understood through the following description.

In steps S700a to S700n, the base station 701 may transmit reference signals to the terminal 702. In this case, reference signals may be transmitted based on CSI prediction-related information included in UE capability information reported by the terminal 702. For example, when the terminal 702 indicates in the UE capability information that CSI prediction is possible, the UE capability information may include various information described in [1], such as the minimum and/or maximum number of auxiliary reference signals, periodicity information of auxiliary reference signals, information on signal(s) (or channel(s)) usable as auxiliary reference signals, and CSI predictable time(s). Therefore, all reference signals transmitted in the steps S700a to S700n may be CSI-RSs, or may include PDCCH(s), PDSCH(s), TRS(s), and/or CSI-RS(s).

It should be noted that FIG. 7 also does not illustrate that a prediction request signal requesting CSI prediction for a specific time (e.g., time B illustrated in FIG. 7) is transmitted from the base station 701 to the terminal 702 in advance. The signal requesting CSI prediction for a specific time (e.g., time B illustrated in FIG. 7) may be transmitted from the base station 701 to the terminal 702 before the step S700a, or may be transmitted to the terminal 702 after the step S700n. If the base station 701 requests CSI prediction information from the terminal 702, a prediction information request may be transmitted to the terminal 702 using the prediction request signal. The prediction request signal may include CSI-RS configuration information and/or auxiliary RS configuration information.

The terminal 702 may receive reference signals transmitted by the base station 701 in the steps S700a to S700n. In this case, if the reference signal in the step S600n is a last reference signal, a time A may be a time at which the terminal 702 starts CSI prediction and/or a time at which the last reference signal is received, as described in [1]. In this case, the base station 701 may transmit the CSI report request information to the terminal 702 in the steps S700a to S700n for transmitting reference signals. The CSI report request information may be transmitted to the terminal 702 on a control channel, for example, PDCCH. The CSI report request information may include information on a target reference signal according to an exemplary embodiment of the present disclosure.

In a step S710, the terminal 702 may perform CSI prediction. In this case, a CSI prediction target time may be the time B. In FIG. 7, a time after 5 ms (from the CSI reporting time) is illustrated as the CSI prediction target time.

In a step S712, the terminal 702 may report CSI. In this case, the predicted CSI may be transmitted at a time when CSI measured based on the CSI-RS received at the time A is reported. Additionally, a CSI report message may include predicted CSI for the time B. Additionally, the CSI report message may further include a CQI for the time of measurement or reporting. Accordingly, the base station 701 may receive the CSI report message in the step S712.

In a step S720, the base station 701 may transmit a target reference signal. A time of transmitting the target reference signal may be a time at which prediction is performed by the terminal 702. In FIG. 7, since the terminal 702 predicts CSI for a time after 5 ms, the target reference signal may be transmitted at the time after 5 ms from the CSI reporting. Accordingly, the terminal 702 may receive the target reference signal in the step S720.

In a step S722, the terminal 702 may measure CSI from the target reference signal. Although not illustrated in FIG. 7, the terminal 702 may compare the measured CSI and the CSI predicted in the step S710. To compare two values, one of the schemes exemplified above may be used. Depending on a result of comparison between the two values, the terminal 702 may determine a quality of a prediction model. As described above, if the quality of the prediction model is greatly reduced, the terminal 702 may perform additional training of the prediction model or deactivate the prediction model.

In a step S724, the terminal 702 may report the CSI. In this case, a time at which the CSI is reported may be a time at which CSI measured based on the received target reference signal is reported. In addition, the CSI reporting in the step S724 may be performed when CSI reporting for the target reference signal is indicated in the CSI report request information described above.

FIG. 7 described above shows a case where the terminal 702 receives reference signal(s) and auxiliary reference signal(s) and performs CSI prediction for the time B, which is a target prediction time. Then, at the target prediction time, the base station 701 may transmit the target reference signal to the terminal 702, and the terminal 702 may measure CSI for the time to measure prediction accuracy. Additionally, the terminal 702 may report the measured prediction accuracy to the base station 701.

In a modified form of the exemplary embodiment described in FIG. 7, in a mobile communication system consisting of a base station and a terminal, when the terminal derives CSI based on prediction and reports it to the base station and the base station transmits a control message or data at the target prediction time when the terminal performs prediction, the terminal may measure prediction accuracy using channel information of a PDCCH or PDSCH.

In addition, as described in FIG. 7, in a mobile communication system consisting of a base station and a terminal, when the terminal derives CSI based on prediction and reports it to the base station, the base station may transmit a target reference signal to the terminal for the purpose of measuring prediction accuracy for a time at which the prediction is performed by the terminal. Then, the terminal may measure CSI based on the target reference signal and report the measured CSI to the base station.

In order to receive a report of the CSI measured at the target prediction time, the base station may transmit CSI report request information including information on the target reference signal to the terminal. In this case, the configuration of the target reference signal may be the same as that of the reference signal used to perform prediction. If the configuration of the target reference signals and that of the reference signal used to perform prediction are the same, the information of the target reference signal may be omitted. Additionally, the CSI report request information may further include resource information for reporting the CSI measured based on the target reference signal.

The operations described as another modified form of the exemplary embodiment of FIG. 7 may be performed periodically. Therefore, the base station may indicate the terminal to configure periodic prediction-based CSI reporting. Accordingly, the terminal may periodically report prediction-based CSI to the base station. In this case, the base station may configure the terminal to perform periodic prediction accuracy measurements. Accordingly, the terminal may be configured to perform periodic prediction accuracy reporting. Here, a periodicity of prediction accuracy measurement and a periodicity of prediction accuracy reporting may be different. The base station may periodically transmit the target reference signal to the terminal to perform periodic prediction accuracy measurements. In this case, the base station may additionally transmit information on whether or not the target reference signal is transmitted or configuration information thereof to the terminal.

In addition to the modified exemplary embodiment of FIG. 7 above, the base station may request suspension of periodic prediction-based CSI reporting or switching to measurement-based current CSI reporting based on the prediction accuracy reported from the terminal. Further, the base station may request an update of the prediction model from the terminal.

[4] Method of Obtaining Training Data for CSI Prediction

In the present disclosure, in a mobile communication system consisting of a base station and a terminal, the terminal may perform CSI reporting based on prediction. In order for the terminal to report predicted CSI to the base station, the terminal may use an AI/ML model as described above. The present disclosure described below mainly assumes that the terminal performs prediction based on an A/ML model. However, the present disclosure is not limited thereto, and an auto regressive model rather than an AI/ML model may be used, or other methods may be applied. However, for convenience of description, the description will be made assuming that an A/ML model is used.

The AI/ML model may require training data for CSI prediction. Therefore, the terminal may request the base station to transmit a reference signal to obtain training data for CSI prediction. When transmission of a reference signal for obtaining training data for CSI prediction is requested from the terminal, the base station may configure a reference signal and transmit it to the terminal. The request for a reference signal for training may include the following information.
(1) Information on predictable time(s) with respect to a reception time of the reference signal
(2) Information on auxiliary reference resource(s) for performing prediction
(3) Reference signal transmission periodicity

Meanwhile, the base station may configure information on the reference signal(s) for training, auxiliary reference signal(s), and target reference signal(s) to the terminal. The terminal may receive reference signals according to the information, and use them as input information for a machine learning model for prediction. Additionally, the terminal may receive a target reference signal for a target prediction time for each reference signal, and use it as objective information for supervised training of the machine learning model.

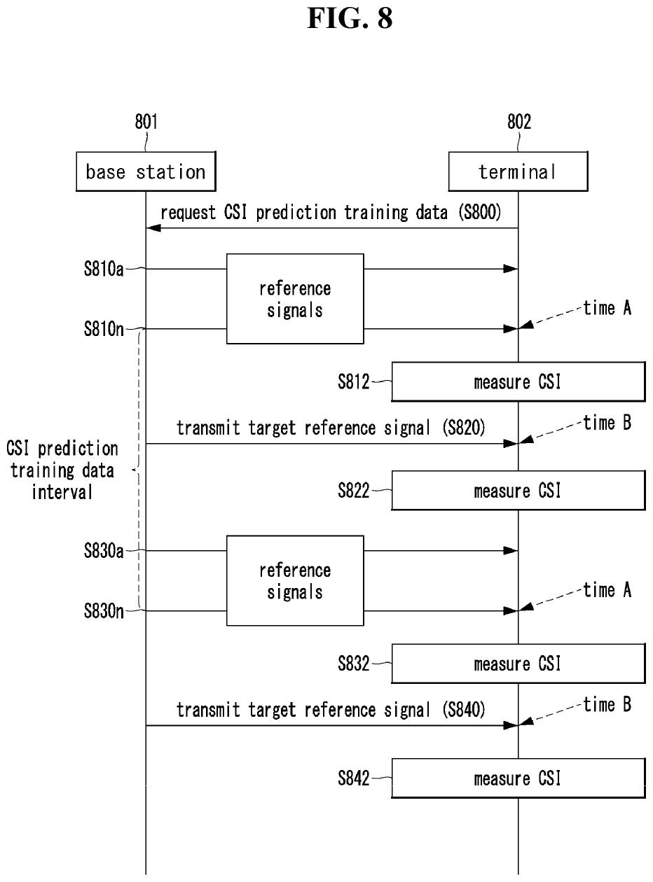

FIG. 8 is a sequence chart illustrating a case when a terminal requests training data for CSI prediction and a training procedure is performed.

Referring to FIG. 8, a base station 801 and a terminal 802 are illustrated. The base station 801 and the terminal 802 illustrated in FIG. 8 may include the same components as the base station 301 and the terminal 302 respectively described in FIG. 3. Therefore, redundant description will be omitted.

In addition, before describing FIG. 8, the description will be made assuming that the base station 801 requests UE capability information from the terminal 802, and in response, the terminal 802 reports the UE capability information to the base station 801. There may be other methods for the base station 801 to obtain information on an AI model and/or ML model for CSI prediction mounted on the terminal 802 in addition to the UE capability information.

However, in the present disclosure, for convenience of description, the case where UE capability information is used will be described as an example. Various information included in the UE capability information according to the present disclosure may be understood through the following description.

In a step S800, the terminal 802 that needs training data for CSI prediction may transmit a CSI training data request message to the base station 801. Accordingly, the base station 801 may receive the CSI training data request message from the terminal 802.

In steps S810a to S810n, the base station 801 may transmit reference signals to the terminal 802. In this case, the reference signals may be transmitted based on CSI prediction-related information included in the UE capability information reported by the terminal 802. Since the CSI prediction-related information has been described in the previous exemplary embodiments, redundant description will be omitted.

Meanwhile, it should be noted that FIG. 8 also does not illustrate that a prediction request signal requesting CSI prediction for a specific time (e.g., time B illustrated in FIG. 8) is transmitted from the base station 801 to the terminal 802 in advance. The signal requesting CSI prediction for a specific time (e.g., time B illustrated in FIG. 8) may be transmitted from the base station 801 to the terminal 802 before the step S800a, or may be transmitted to the terminal 802 after the step S800n. If the base station 801 requests CSI prediction information from the terminal 802, a prediction information request may be transmitted to the terminal 802 using the prediction request signal. The prediction request signal may include CSI-RS configuration information and/or auxiliary RS configuration information.

The terminal 802 may receive reference signals transmitted by the base station 801 in the steps S810a to S810n. In this case, if the reference signal in the step S810n is a last reference signal, a time A may be a time at which the terminal 802 starts CSI prediction and/or a time at which the last reference signal is received, as described in [1].

In a step S812, the terminal 802 may perform CSI measurement. In addition, the terminal 802 may predict CSI for the time B which is a target prediction time. The prediction may be made using the AI/ML model as described above.

In a step S820, the base station 801 may transmit a target reference signal to the terminal 802. In this case, the terminal 802 may transmit the target reference signal based on a CSI predictable time included in the UE capability report of the terminal 802 or the information included in the CSI prediction training data request message. Accordingly, the terminal 802 may receive the target reference signal from the base station 801 in the step S802.

In a step S822, the terminal 802 may perform CSI measurement. In this case, if the prediction is made using the AI/ML model in the step S812, the prediction information may be corrected based on a result of the CSI measurement.

Thereafter, the base station 801 may transmit reference signals to the terminal 802 in steps S830a to S830n. Steps S832 to S842 performed thereafter may be repetitive operations corresponding to the steps S812 to S842 described above.

In addition, as illustrated in FIG. 8, a CSI prediction training data interval may be set to a period from a transmission time of the last reference signal until all of the next reference signals are transmitted. The base station may repeat the above-described operation as many intervals as the terminal needs to perform the training for CSI prediction.

The present disclosure described above describes a method and an apparatus for reporting CSI based on prediction by applying ML technology in a mobile communication network. More specifically, the method of configuring prediction-based CSI reporting and CSI resources at a transmitter, method of monitoring prediction quality, and the like have been described.

The present disclosure described above has the following advantages.

First, prediction-based CSI reporting related capability of the terminal is delivered to the base station. The base station receiving it may configure reference signal(s) and/or auxiliary reference signal(s) in a form that allows the terminal to perform prediction. In this case, the terminal may request auxiliary reference signal configuration defining not only a fixed time interval between a reference signal and an auxiliary reference signal, but also the number of auxiliary reference signals within the maximum time window based on a transmission time of the reference signal. In addition, not only CSI-RS(s) but also a PDCCH or PDSCH can be configured as the auxiliary reference signal, thereby reducing a delay and overhead for receiving the auxiliary reference signal.

Second, there is an advantage in that prediction for a time required by the base station can be requested by transmitting information on predictable time(s) supported by the terminal to the base station. In addition, the terminal can perform CSI reporting for a time with the best channel quality among several times requested by the base station.

Third, by providing a method for measuring prediction accuracy of the terminal, the accuracy of predictions already made by the terminal can be measured thereafter. The terminal and/or base station may identify whether there is a problem in CSI prediction based on the identified accuracy. In addition, when prediction-based CSI reporting is requested, the terminal may operate in a fallback mode in which current CSI is reported if the predicted CSI is inaccurate or insufficient. In addition, if prediction accuracy is low, additional training can be performed to improve prediction accuracy.

Fourth, transmission of reference signals may be configured for initial training of the prediction model or collection of training data for further training.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
transmitting channel state prediction-related information to a base station;
receiving a channel prediction request signal for a first time instance from the base station;
receiving auxiliary reference signal(s) (RS(s)) and a first RS from the base station based on the channel state prediction-related information; and
transmitting channel prediction information for the first time instance to the base station,
wherein the channel state prediction-related information includes information indicating that channel state information prediction of the terminal is possible, and the channel prediction request signal includes configuration information of the auxiliary RS(s) and configuration information of the first RS.

2. The method according to claim 1, wherein the channel state prediction-related information includes at least one of information on a minimum time interval between the RSs or information on a number of the auxiliary RS(s).

3. The method according to claim 1, wherein the channel state prediction-related information includes information on a type of the auxiliary RS(s), and the auxiliary RS(s) include a channel state information (CSI)-RS, channel information of a received physical downlink control channel (PDCCH) resource, channel information of a received physical downlink shared channel (PDSCH) resource, or tracking reference signal.

4. The method according to claim 3, wherein when the auxiliary RS(s) include a PDCCH, the channel prediction request for the first time instance is received on the PDCCH.

5. The method according to claim 1, wherein the channel prediction information for the first time instance is transmitted to the base station at a time of reporting channel state information (CSI) measured based on reception of the first RS.

6. The method according to claim 1, further comprising:
generating fallback CSI when channel prediction for the first time instance is impossible or when a channel prediction accuracy for the first time instance is equal to or less than a preset value; and
transmitting the fallback CSI to the base station,
wherein the fallback CSI includes CSI based on measurement of the first RS.

7. The method according to claim 1, further comprising: receiving a second RS for measuring accuracy of the channel prediction information for the first time instance from the base station at the first time.

8. The method according to claim 7, further comprising:
generating first CSI based on measurement of the second RS;
comparing the channel prediction information for the first time instance and the first CSI;
identifying the accuracy of the channel prediction information based on a result of the comparison; and
transmitting a CSI report message including the accuracy of the channel prediction information to the base station.

9. The method according to claim 1, further comprising:
transmitting a channel state prediction training data request message to the base station when a channel prediction model for channel prediction needs to be trained;
receiving configuration information of a second RS for training the channel prediction model from the base station; and
collecting training data of the channel prediction model using the second RS received from the base station, based on the configuration information of the second RS.

10. A terminal comprising at least one processor, wherein the at least one processor causes the terminal to perform:
transmitting channel state prediction-related information to a base station;
receiving a channel prediction request signal for a first time instance from the base station;
receiving auxiliary reference signal(s) (RS(s)) and a first RS from the base station based on the channel state prediction-related information; and
transmitting channel prediction information for the first time instance to the base station,
wherein the channel state prediction-related information includes information indicating that channel state information prediction of the terminal is possible, and the channel prediction request signal includes configuration information of the auxiliary RS(s) and configuration information of the first RS.

11. The terminal according to claim 10, wherein the channel state prediction-related information includes at least one of information on a minimum time interval between the RSs or information on a number of the auxiliary RS(s).

12. The terminal according to claim 10,
wherein the channel state prediction-related information includes information on a type of the auxiliary RS(s), and the auxiliary RS(s) include a channel state information (CSI)-RS, channel information of a received physical downlink control channel (PDCCH) resource, channel information of a received physical downlink shared channel (PDSCH) resource, or tracking reference signal; and
wherein when the auxiliary RS(s) include a PDCCH, the channel prediction request for the first time instance is received on the PDCCH.

13. The terminal according to claim 10, wherein the at least one processor further causes the terminal to perform: transmitting the channel prediction information for the first time instance to the base station at a time of reporting channel state information (CSI) measured based on reception of the first RS.

14. The terminal according to claim 10, wherein the at least one processor further causes the terminal to perform:
generating fallback CSI when channel prediction for the first time instance is impossible or when a channel prediction accuracy for the first time instance is equal to or less than a preset value; and
transmitting the fallback CSI to the base station,
wherein the fallback CSI includes CSI based on measurement of the first RS.

15. The terminal according to claim 10, wherein the at least one processor further causes the terminal to perform:
receiving a second RS for measuring accuracy of the channel prediction information for the first time instance from the base station at the first time;
generating first CSI based on measurement of the second RS;
comparing the channel prediction information for the first time instance and the first CSI;
identifying the accuracy of the channel prediction information based on a result of the comparison; and
transmitting a CSI report message including the accuracy of the channel prediction information to the base station.

16. The terminal according to claim 10, wherein the at least one processor further causes the terminal to perform:
transmitting a channel state prediction training data request message to the base station when a channel prediction model for channel prediction needs to be trained;
receiving configuration information of a second RS for training the channel prediction model from the base station; and
collecting training data of the channel prediction model using the second RS received from the base station, based on the configuration information of the second RS.

17. A method of a base station, comprising:
receiving channel state prediction-related information from a terminal;
transmitting a channel prediction request signal for a first time instance to the terminal;
transmitting auxiliary reference signal(s) (RS(s)) and a first RS to the terminal based on the channel state prediction-related information;
transmitting a channel prediction request signal for the first time instance to the terminal; and
receiving channel prediction information for the first time instance from the terminal,
wherein the channel state prediction-related information includes information indicating that channel state information prediction of the terminal is possible, and the channel prediction request signal includes configuration information of the auxiliary RS(s) and configuration information of the first RS,
wherein the channel state prediction-related information further includes information indicating the capability of predicting channel state information of the terminal and auxiliary RS-related information, and
wherein the channel prediction request signal includes configuration information of the auxiliary RS(s) and configuration information of the first RS.

18. The method according to claim 17,
wherein the channel state prediction-related information includes information on a type of the auxiliary RS(s), and the auxiliary RS(s) include a channel state information (CSI)-RS, channel information of a received physical downlink control channel (PDCCH) resource, channel information of a received physical downlink shared channel (PDSCH) resource, or tracking reference signal; and
wherein when the auxiliary RS(s) include a PDCCH, channel prediction for the first time instance is requested from the terminal by using the PDCCH.

19. The method according to claim 17, further comprising:
transmitting a second RS for measuring accuracy of the channel prediction information for the first time instance to the terminal at the first time; and
receiving first channel state information (CSI) based on measurement of the second RS and the accuracy of the channel prediction information from the terminal.

20. The method according to claim 17, further comprising:
receiving a channel state prediction training data request message from the terminal;
transmitting configuration information for a second RS for training a channel prediction model to the terminal;
transmitting the second RS to the terminal based on the configuration information of the second RS; and
transmitting a third RS to the terminal at a second time, which is a prediction time of the terminal based on the configuration information of the second RS.
